(19) United States
(12) Patent Application Publication
(10) Pub. No.: US 2023/0380633 A1
(43) Pub. Date: Nov. 30, 2023

(54) GRILLING RACK

(71) Applicant: METAL FUSION, INC., Jefferson, LA (US)

(72) Inventors: Norman Bourgeois, Jefferson, LA (US); Barbara Bourgeois, Jefferson, LA (US); Michael Bourgeois, Kenner, LA (US)

(21) Appl. No.: 18/324,495

(22) Filed: May 26, 2023

Related U.S. Application Data
(63) Continuation of application No. 17/235,158, filed on Apr. 20, 2021, now Pat. No. 11,659,960.
Application No. 17/235,158 is a continuation of application No. 16/030,999, filed on Jul. 10, 2018, now abandoned.
Application No. 16/030,999 is a continuation of application No. 15/332,386, filed on Oct. 24, 2016, now Pat. No. 10,016,094.
Application No. 15/332,386 is a continuation of application No. 13/363,057, filed on Jan. 31, 2012, now Pat. No. 9,474,294.
Application No. 13/363,057 is a continuation-in-part of application No. 13/151,800, filed on Jun. 2, 2011, now Pat. No. 8,919,244.
(60) Provisional application No. 61/350,826, filed on Jun. 2, 2010.
(60) Provisional application No. 61/438,077, filed on Jan. 31, 2011.

(51) Int. Cl. A47J 43/18; A23P 20/20; A23P 20/25; A23L 19/00; A23L 21/25; A47J 37/07

(52) U.S. Cl. CPC A47J 43/18; A23P 20/20; A23P 20/25; A23L 19/05; A23L 21/25; A47J 37/07

(57) ABSTRACT

A food grilling rack provides a frame defined by a plurality of connected side walls forming a closed geometric shape. The frame includes a lower corrugated sheet that provides multiple troughs, each trough having a lowest portion. The lower sheet is attached to at least some of the side walls. An upper sheet of material is supported (e.g., removably) above the sheet of corrugated material. A sheet with openings slides into the frame aligning the openings with the lowest part of the trough. A food stuffing apparatus provides a receptacle having an interior, an upper end portion with a larger opening and a lower end portion with a smaller opening, and a tapering portion in between the upper and lower end portions.

### CROSS-REFERENCE TO RELATED APPLICATIONS

This is a continuation of U.S. patent application Ser. No. 17/235,158, filed Apr. 20, 2021 (issuing as U.S. Pat. No. 11,659,960 on May 30, 2023), which is a continuation of U.S. patent application Ser. No. 16/030,999, filed Jul. 10, 2018 (now abandoned), which is a continuation of U.S. patent application Ser. No. 15/332,386, filed Oct. 24, 2016 (now U.S. Pat. No. 10,016,094 on Jul. 10, 2018), which is a continuation of U.S. patent application Ser. No. 13/363,057, filed Jan. 31, 2012 (now U.S. Pat. No. 9,474,294 on Oct. 25, 2016), which is a continuation-in-part of U.S. patent application Ser. No. 13/151,800, filed Jun. 2, 2011 (now U.S. Pat. No. 8,919,244 on Dec. 23, 2014), which is a nonprovisional of both U.S. Provisional Patent Application Ser. No. 61/350,826, filed Jun. 2, 2010, and U.S. Provisional Patent Application Ser. No. 61/438,077, filed Jan. 31, 2011, all of which applications are hereby incorporated herein by reference and priority of/to all of which applications are hereby claimed.

### BACKGROUND OF THE INVENTION

### 1. Field of the Invention

The present invention relates to food grilling racks that can be used to contain food and then be placed upon a cooking surface such as an outdoor grilling surface. The present invention also relates to a method and apparatus for stuffing a selected food stuffing into a food item such as a pepper or other vegetable food item. More particularly, the present invention relates to an apparatus that holds a volume of food stuffing material (e.g., a rice based stuffing, cheese based stuffing or a mixture of meat and cheese and possibly other food items).

### 2. General Background of the Invention

Food items are often placed upon a perforated plate, which is then placed upon a barbecue pit, outdoor grill or other outdoor cooking surface. Such perforated plates are commercially available. At times, they are provided with handles for enabling a user to lift and move the plate before and after use. It is common and known to grill a number of different food items on such perforated grilling plates, such as onions, peppers, corn, and other food items.

Some food items such as jalapeno peppers or bell peppers can be stuffed with food items such as a breaded mixture of rice and meat or seafood. In such a case, users often cut the pepper transversely or longitudinally and fill each of the cut halves with a selected stuffing or filling.

One of the problems with the prior art grilling racks is that the food items can often fall in between the openings or become stuck in the openings.

### BRIEF DESCRIPTION OF DRAWINGS

For a further understanding of the nature, objects, and advantages of the present invention, reference should be had to the following detailed description, read in conjunction with the following drawings, wherein like reference numerals denote like elements and wherein:

FIG. 1 is a perspective view of a preferred embodiment of the present invention;

FIG. 2 is a partially cut away perspective view of a preferred embodiment of the present invention;

FIG. 3 is a sectional view taken along lines 3-3 of FIG. 2;

FIG. 4 is a perspective view of a preferred embodiment of the present invention showing the upper plate removed;

FIG. 5 is a perspective view of an alternate embodiment of the apparatus of the present invention;

FIG. 6 is a sectional view of an alternate embodiment of the apparatus of the present invention taken along lines 6-6 of FIG. 5;

FIG. 7 is a perspective view of an alternate embodiment of the apparatus of the present invention;

FIG. 8 is an exploded perspective view of an alternate embodiment of the apparatus of the present invention;

FIG. 9 is a partial sectional view of the preferred embodiment of the present invention showing the food dispensing funnel;

FIG. 10 is a perspective view of the preferred embodiment of the present invention showing the food dispensing plunger or push rod;

FIG. 11 is a perspective view of the preferred embodiment of the present invention showing the food dispensing plunger and push rod;

FIGS. 12-13 are sectional views illustrating the method of the present invention; and

FIG. 14 is a perspective view illustrating the method of the present invention.

### DETAILED DESCRIPTION OF THE INVENTION

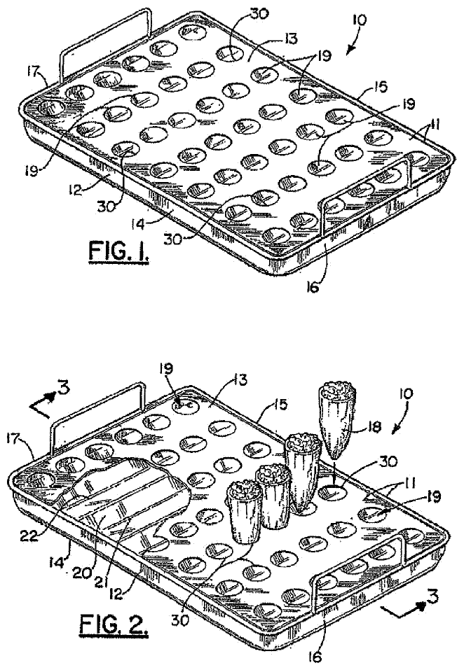

FIGS. 1-4 show a preferred embodiment of the apparatus of the present invention designated generally by the numeral 10. Grilling rack 10 is in the form of a two part frame 11 which can be metallic (e.g., aluminum or stainless steel). Frame 11 has a lower section 12 and an upper section 13. Upper section 13 is a removable plate that can be perforated or apertured.

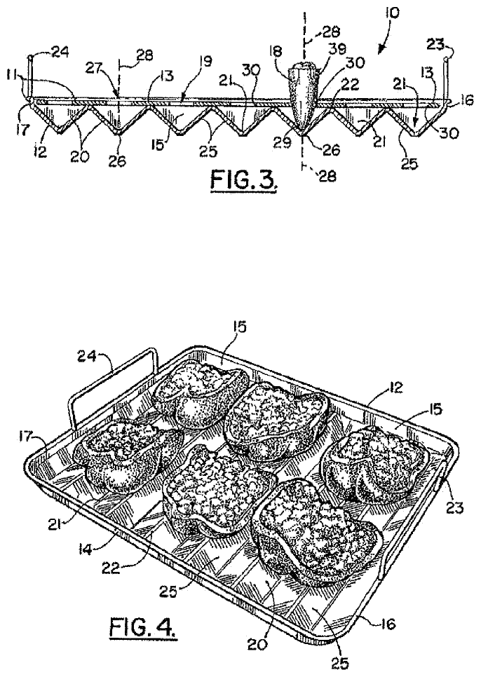

The upper section or plate 13 can be in the form of a perforated plate that can be removed from the lower section 12 by lifting the upper section 13 upwardly. Lower section 12 has a corrugated bottom panel 20 (see FIGS. 2-4) that has troughs 21 and peaks 22 (See FIGS. 2-3). Bottom panel 20 can be of a mesh material (e.g., stainless steel mesh) or of solid plate metal (e.g., stainless steel). Lower section 12 can be generally rectangular, providing side walls 14, 15 and end walls 16, 17. Each end wall 16, 17 can be provided with a handle. End wall 16 has a handle 23. End wall 17 has a handle 24. Each trough 21 and peak 22 is connected with an inclined panel 25. (See FIG. 4.) While multiple troughs 21 are shown, a single trough 21 could be provided on an elongated lower section 12 having a single row of openings 19 in an upper section 13 (as an alternate embodiment).

The upper section or plate 13 nests within the side walls 14, 15 and end walls 16, 17 and rests upon the plurality of peaks 22 of corrugated bottom panel 20 (see FIGS. 1-3). The lower section 12 can be of welded metal construction including troughs 21 which can be formed of sections of angle members, flanged members or the like that are welded together. Alternatively, a single sheet of material can be corrugated to the shape of lower section 12 using a stamp or die.

Each trough 21 has a trough 21 lower end 26 that is centered upon the center 27 of an opening 19 as seen by referring to reference line 28 in FIG. 3. In this fashion, when an elongated food item (such as an elongated pepper 18) is placed in an opening 19, the lower end of the pepper 18 also registers in the V-shaped trough 21 and more particularly in the lower most portion 26 thereof (see FIG. 3).

When grilling stuffed elongated peppers (e.g., a jalapeno), the upper section or plate 13 is placed upon the lower section 12 (see FIGS. 1-3). Notice in FIG. 3 that the center 27 of each opening 19 is vertically aligned with the lowest end 26 of a trough 21 as indicated by the dotted reference line 28 in FIG. 3. Lower end 29 of pepper 18 rests in lower end 26 of trough 21. Circular edge 30 that defines each opening 19 engages and supports pepper 18 in between its upper end 39 and lower end 29 as seen in FIGS. 2-3. Upper section or plate 13 is shown having an array of openings 19. In FIGS. 1-2, there are seven rows of openings 19, six openings 19 in each row. However, more or fewer rows can be provided. Each row can provide any selected number of openings 19.

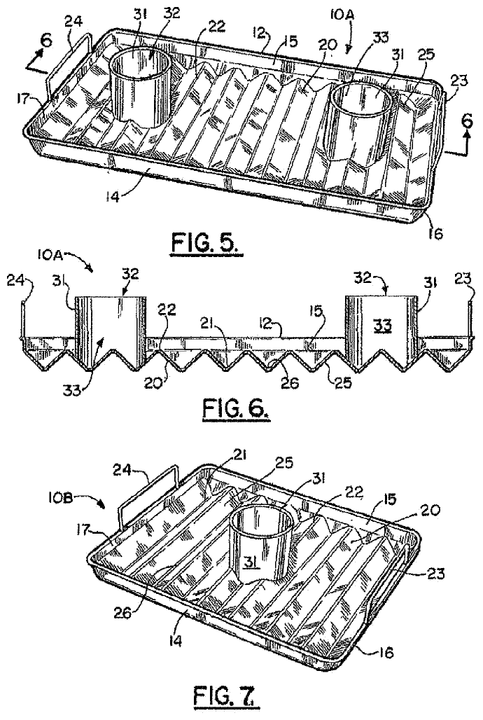

In FIGS. 5-8, an alternate version of the grilling rack is designated by the numeral 10A in FIGS. 5-6 and 8 and numeral 10B in FIG. 7. For the racks 10A-10B, there is no upper section or plate 13.

In FIGS. 5, 6, and 8, the rack 10A includes a pair of cylinders or cylindrically shaped members or receptacles 31. Each cylinder 31 has an open top 32 and an interior 33 for holding a vegetable or other food item or a container of seasoning such as an opened can 34 of any selected beverage. Rack 10B in FIG. 7 provides only cylinder 31. Each receptacle 31 is attached to corrugated bottom panel 20. Receptacle 31 can be placed anywhere on the rack 10A. Panel 20 can be a single sheet of corrugated material or a plurality of tapered or V-shaped members welded together. Corrugated panel 20 can have handles 23, 24 connected thereto (e.g., welded).

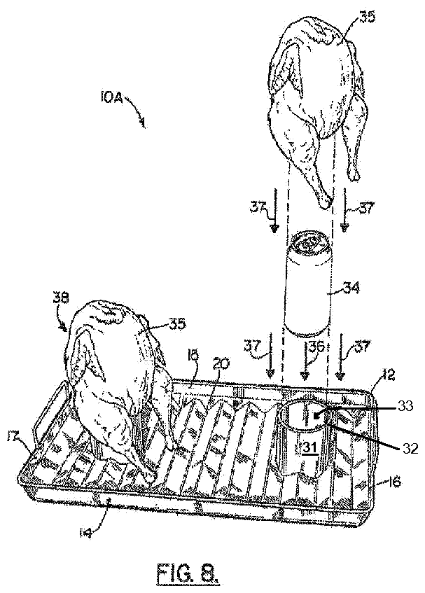

The present invention provides an improved grilling rack apparatus that enables a user to cook many food items including elongated peppers that have been stuffed with a filler or filling. For the embodiment of FIGS. 4-8, food item 35 such as poultry can be supported upon (e.g. skewered) a cylinder 31 that contains flavoring (e.g. opened can 34 of any selected liquid or spices or vegetables). Arrow 36 in FIG. 8 illustrates placement of can 34 within interior 33 of cylinder 31 via open top 32. A food item 35 such as a chicken can be placed over (e.g., skewered) the combination of opened can 34 and cylinder 31 as indicated by arrows 37 in FIG. 8. Such final position of the food item (e.g., poultry carcass, chicken, etc.) is designated as 38 in FIG. 8 wherein the can 34 (or other spice or flavoring) occupies interior 33 of cylinder/receptacle 31 and the food item 35 is skewered over both cylinder 31 and the contained can 34 or spice or flavoring. Receptacle 31 can be placed anywhere on the rack 10B.

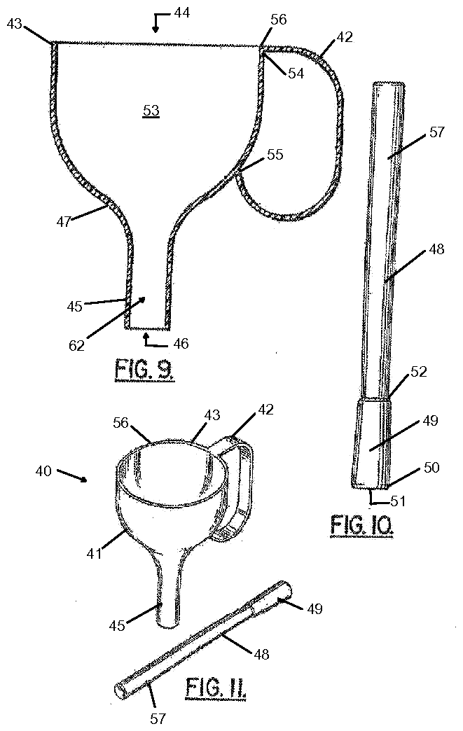

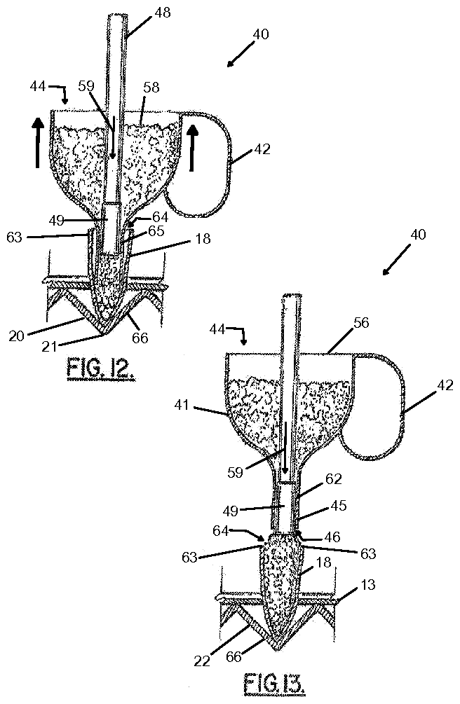

FIGS. 9-11 show the food dispensing funnel, plunger, push rod. FIGS. 12-14 show the method of the present invention. In FIG. 11 there is a food stuffing apparatus, designated generally by the numeral 40. Food stuffing apparatus 40 includes a receptacle or funnel 41 that can contain a volume of a selected food stuffing 58 (e.g., rice or cheese or meat based stuffing or dressing). Receptacle 41 can be of metallic (e.g., stainless steel) or plastic (e.g., any food grade plastic) construction. This food stuffing or dressing 58 can be added to interior 53 of receptacle 41 via an open top 44 at upper end portion 43. The receptacle 41 has upper end portion 43 and lower end portion 45. Tapered portion 47 joins upper end portion 43 to lower end portion 45. (See FIGS. 9, 11.)

Upper end portion 43 can include a circular rim or edge 56. A dispensing outlet opening 46 is provided at lower end portion 45. Receptacle 41 can be manually supported and manipulated using handle 42 which is attached to the outer surface of receptacle 41 at attachments 54, 55. (See FIGS. 9, 11.)

Plunger 48 has head 49 with lower end portion 50. Head 49 has a circular, generally flat end surface 51. Plunger 48 has a handle 57 attached at joint 52 to plunger head 49. Head 49 can be generally cylindrically shaped or can have a taper as shown in FIG. 10. Outlet opening 46 has a circular configuration that closely matches the size and shape of end surface 51 of plunger 48. Outlet opening 46 can be of the same diameter or slightly larger in diameter than plunger 48 surface 51. Head 49 is preferably of a food grade plastic or metal material. Handle 57 can be of wood, plastic or metal.

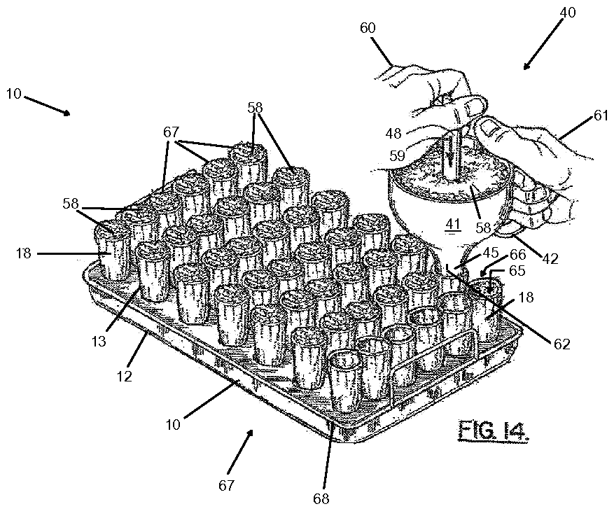

FIGS. 12-14 illustrate more particularly the method of the present invention. In FIGS. 12-14, there can be seen an array 67 of peppers 18 placed in grilling rack 10. As shown in the FIGS. 1-8 and as discussed in the preceding, corresponding text, the grilling rack 10 has a lower section 12, upper section 13, a plurality of openings 19 and a corrugated bottom panel 20. Each pepper 18 is first cut using a knife to form a transverse cut 63 and a pepper opening 64 through which food stuffing can enter the pepper cavity 65. The cavity 65 extends between pepper opening 64 and lower end 66 as shown in FIGS. 12 and 13.

After each pepper 18 is cut to provide the pepper opening 64 and to expose cavity 65, the pepper 18 is placed on rack 10 with opening 64 facing up as shown in FIG. 14. Once each of the openings 19 of rack 10 is fitted with a pepper 18 as shown in FIG. 14, a user fills each pepper 18 cavity 65 with food stuffing 58 of the user's choice. During the filling of each pepper 18 cavity 65 with food stuffing 58, a user positions one hand 61 to hold the handle 42 of receptacle or funnel 41. The user grasps plunger 48 with the other hand 60 as shown in FIG. 14. An up and down movement of the plunger 48 relative to the receptacle 41 forces the stuffing 58 through the cylindrically shaped channel 62 at lower end portion 45 of receptacle 41.

FIG. 12 illustrates a downward movement of plunger 48 as indicated by arrow 59 wherein stuffing 58 is pushed by plunger head 49 through lower end 45, through channel 62, and into pepper 18 cavity 65. Note in FIG. 12 that the lower end portion 45 of receptacle 41 is sized and shaped to fit inside of pepper 18 lower end of cavity 66. The external diameter of lower end portion 45 at dispensing outlet opening 46 is preferably about the same diameter or is a smaller diameter when compared to the diameter of pepper opening 64. This arrangement can be seen in FIGS. 12 and 13.

By using the method of the present invention, a user can prepare an entire array 67 of peppers upon grilling rack 10 for placement in a cooking device, oven, barbeque pit, or the like.

The method of the present invention enables an entire array 67 of peppers to be supported in a position that places the lower end portion of the pepper in trough 21 of grilling rack 10 while orienting the transversely cut pepper opening 64 upwardly. In this fashion, the opening 64 easily receives lower end portion 45 and opening 46 of receptacle 41 as shown in FIG. 12. The user raises and lowers the plunger 48 repeatedly to push food stuffing into cylindrically shaped channel 62 and then into cavity 65 until the pepper 18 cavity 65 is filled with stuffing as shown in FIGS. 12 and 13. In FIG. 14, most of the peppers 18 have been stuffed with food stuffing 58. A final row at 68 shows six peppers 18 that have not yet been filled with food stuffing 58. Once the user fills the cavity 65 of each pepper 18, the array 67 of peppers supported upon rack 10 are placed in heat transfer contact with a selected cooking device, smoker, camp fire, barbeque pit, oven or the like.

### PARTS LIST

The following is a list of parts and materials suitable for use in the present invention:

| Parts | |
|---|---|
| Number | Description |
| 10 | grilling rack |
| 10A | grilling rack |
| 10B | grilling rack |
| 11 | frame |
| 12 | lower section |
| 13 | upper section/plate |
| 14 | side wall |
| 15 | side wall |
| 16 | end wall |
| 17 | end wall |
| 18 | pepper |
| 19 | opening |
| 20 | corrugated bottom panel |
| 21 | trough |
| 22 | peak |
| 23 | handle |
| 24 | handle |
| 25 | inclined panel |
| 26 | lower end |
| 27 | center of opening |
| 28 | reference line |
| 29 | lower end |
| 30 | circular edge |
| 31 | cylinder/receptacle |
| 32 | open top |
| 33 | interior |
| 34 | can |
| 35 | food item |
| 36 | arrow |
| 37 | arrow |
| 38 | position |
| 39 | upper end |
| 40 | food stuffer/food stuffing apparatus |
| 41 | receptacle/funnel |
| 42 | handle |
| 43 | upper end portion |
| 44 | open top |
| 45 | lower end portion |
| 46 | dispensing outlet opening |
| 47 | tapered portion |
| 48 | plunger |
| 49 | plunger head |
| 50 | lower end portion |
| 51 | flat, circular end surface |
| 52 | joint |
| 53 | interior |
| 54 | attachment |
| 55 | attachment |
| 56 | rim/edge |
| 57 | handle |
| 58 | food stuffing |
| 59 | arrow |
| 60 | user's hand |
| 61 | user's hand |
| 62 | cylindrically shaped channel |
| 63 | transverse cut |
| 64 | pepper opening |
| 65 | cavity |
| 66 | lower end of cavity |
| 67 | array of peppers |
| 68 | final row |

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1-59. (canceled)

60. A method of preparing and grilling stuffed food articles comprising the steps of:
(a) providing a food stuffer, the food stuffer including:
(i) a funneling portion, the funneling portion including a body,
the body having an upper portion with an open top and the upper portion having an upper body interior portion,
and the body having a lower end portion,
connected to the upper portion at a connection joint,
the lower end portion having a lower body interior portion,
the open top having an open top perimeter and
the lower portion having a dispensing outlet
with a dispensing outlet perimeter that is closed,
the closed dispensing outlet perimeter being smaller than the open top perimeter,
the upper end portion having an expanding cross sectional area between the connection joint and the open top,
the lower end portion having a generally cylindrical shape
with a solid wall from the joint to the dispensing outlet, and
a handle attached to the body; and
(ii) a plunger, the plunger including first and second ends, the second end having a second end circular plunger perimeter that is closed and closely conforms to the closed dispensing outlet perimeter around the entire said second end circular plunger perimeter and closed dispensing outlet perimeter;
(b) providing a plurality of peppers, each of the plurality of peppers having a longitudinal axis and pepper cavity, along with an upper opening providing access to the pepper cavity, and vertically orienting each of the plurality of peppers;
(c) placing a first quantity of stuffing into the upper body interior portion;
(d) after step “c”, while a user's first hand supports the funneling portion via the handle such that the dispensing outlet is placed inside a cavity of a first pepper of the plurality of peppers, a second hand of the user causing the second end of the plunger to move through the upper body interior portion via the open top, and into the lower body interior portion, with the second end passing through the lower body interior portion and becoming closely spaced to the dispensing outlet, thereby causing stuffing from the first quantity of stuffing to move from the upper body interior portion into the lower body interior portion, and exit the dispensing outlet and enter the cavity of the first pepper of the plurality of peppers wherein, when in the lower body interior portion no stuffing passes thru the second end circular plunger perimeter that is closed;
(e) after step “d”, and without placing a second quantity of stuffing into the upper body interior portion, while the user's first hand supports the funneling portion via the handle, the user's second hand retracting the plunger second end upwardly from the dispensing outlet causing the second end to move away from the dispensing outlet, and next the user's second hand causing the plunger second end to move downwardly toward and becoming closely spaced to the dispensing outlet, thereby causing additional stuffing from the first quantity of stuffing located in the upper body interior portion to move from the upper body interior portion into the lower body portion, and to exit the dispensing outlet and enter the cavity of the first pepper of the plurality of peppers;
(f) repeating steps “d” and “e” with up and down movements of the second end of the plunger relative to the dispensing outlet until the cavity of the first pepper of the plurality of peppers is substantially filled with stuffing from the first quantity of stuffing, wherein the dispensing outlet is moved upwardly relative to first pepper of the plurality of peppers; and
(g) after step “f” placing the dispensing outlet in a cavity of a second pepper of the plurality of peppers and reciprocating the second end of the plunger relative to the dispensing outlet until the cavity of the second pepper of the plurality of peppers is substantially filled with stuffing.

61. The method of claim 60, wherein plunger is linearly reciprocated up and down during steps “d”, “e”, and “f”, and wherein the dispensing outlet perimeter is circular and the second end perimeter of the plunger is circular.

62. The method of claim 60, wherein the second end of the plunger passes through the dispensing outlet during steps “d”, “e”, and “f”.

63. The method of claim 60, wherein the user's hand causes the dispensing outlet to be raised during steps “d”, “e”, and “f”.

64. The method of claim 60, wherein the dispensing outlet located in the cavity of the first pepper of the plurality of peppers is raised relative to the first pepper during steps “d”, “e”, and “f” at the same time as the user's second hand causes the second end of the plunger to be lowered.

65. The method of claim 60, wherein the second end of the plunger has a frustoconically tapered area with first and second ends of the tapered area having first and second cross sectional areas, and with second end of the tapered area being closer to the second end of the plunger and with the second cross sectional area being larger than the first cross sectional area of the tapered area.

66. The method of claim 60, wherein the lower end portion has a constant interior diameter from the dispensing outlet to the connection joint, and the upper portion of the body having a curvilinear area between the open top and the connection joint.

67. The method of claim 60, wherein in step “b” the plurality of peppers are arranged in a rectangular array format, and steps of “c” through “f” are performed for each of the plurality of peppers until each of their cavities interiors are filled with stuffing.

68. A method of preparing and grilling an elongated pepper food item comprising the steps of:
(a) providing an elongated pepper food item stuffing apparatus, the elongated pepper food stuffing apparatus including:
(i) a hopper, the hopper having
a receiving end with a receiving opening,
the receiving end having a sloping section,
an ejecting end with an ejecting opening,
the ejecting opening being smaller than the receiving opening, and
a connection joint between the receiving end and the ejecting end,
the ejecting end being a cylinder extending between the connection joint and the ejecting opening, wherein the cylinder has a closed circular perimeter extending between the connection joint and the ejecting opening, and
a hopper interior located between the receiving opening and ejecting opening,
(ii) a baton, the baton having
an elongated body with first and second spaced apart ends;
the second end having an area
that closely conforms to the area of the ejecting opening,
wherein the second spaced apart end is closed;
(b) providing an elongated pepper food item having a longitudinal axis and cavity, vertically orienting the elongated pepper food item, cutting the elongated pepper food to create a food item opening providing access to the cavity;
(c) placing a first quantity of stuffing in the hopper;
(d) while a user's first hand supports the hopper, a second hand of the user moves the baton in the hopper interior such that the second end becomes closely spaced to the ejecting outlet thereby causing stuffing to be discharged from the ejection outlet and enter the cavity of the elongated pepper food item;
(e) while the user's first hand supports the hopper, the user's second hand reciprocates the baton up and down relative to the hopper thereby causing at least one second quantity of stuffing to be discharged from the ejection outlet each time the baton reciprocates without adding another first quantity of stuffing in the hopper, wherein at least one second quantity is a subset of the first quantity and enters the cavity of the elongated pepper food item until the enough stuffing has entered the cavity of the elongated pepper food item to substantially fill the cavity; and
(f) wherein when in the second spaced apart end is located between the connection joint and the ejection end, no stuffing passes by the closed second spaced apart end of the baton.

69. The method of claim 68, wherein the baton is reciprocated up and down linearly during step “e”, and wherein the dispensing outlet perimeter is circular and the second end perimeter of the plunger is circular.

70. The method of claim 68, wherein the second end of the baton passes through the ejecting outlet during steps “d” and “e”.

71. The method of claim 68, wherein the ejecting outlet of the hopper is inserted into the cavity of the pepper in step “d” and is raised relative to the cavity during step “e”.

72. The method of claim 68, wherein a handle is attached to the hopper and the user's first hand supports the handle during steps “d” and “e”.

73. The method of claim 68, wherein the ejecting outlet located in the cavity of the elongated pepper food item is raised relative to the elongated pepper food item during step “e” at the same time as the user's second hand causes the baton to be lowered relative to the hopper.

74. The method of claim 68, wherein the baton has first and second baton ends, and a frustoconically tapered area with first and second ends of the tapered area having first and second cross sectional areas, and with second end of the tapered area being closer to the second baton end of the baton and with the second cross sectional area being larger than the first
